(19) United States
(12) Patent Application Publication
(10) Pub. No.: US 2024/0228397 A1
(43) Pub. Date: Jul. 11, 2024

(54) METHOD AND SYSTEM FOR PRODUCING A FERTILIZER FROM CACTUS PLANTS

(71) Applicant: WeWant LLC, North Las Vegas, NV (US)

(72) Inventors: Jesus Martínez, Indian Head Park, IL (US); Jorge Bildo Saravia Fuentes, Durango (MX); Samuel Vinson, Chicago, IL (US)

(21) Appl. No.: 18/560,034

(22) PCT Filed: May 10, 2022
(86) PCT No.: PCT/US2022/028499

§ 371 Date: Nov. 9, 2023

Related U.S. Application Data
(60) Provisional application No. 63/187,062, filed on May 11, 2021.

(51) Int. Cl. C05F 17/10; C05F 5/00; C05F 17/993

(52) U.S. Cl. CPC C05F 17/10; C05F 5/002; C05F 17/993

(57) ABSTRACT

Various implementations of the present disclosure are directed systems and methods of preparing a fertilizer product from cactus. The method includes grinding cladodes of one or more cactus plants into ground cactus and selecting prickly pear fruits from the one or more cactus plants. The method further includes combining the ground cactus, the selected prickly pear fruits, water, and a ruminal fluid in a first container to form a mixture. The method further includes storing the mixture in the first container for a first time period such that the mixture reacts to form a digestate. The method further includes storing the digestate in the first container or a second container for a second time period such that the digestate forms the fertilizer product.

### CROSS-REFERENCE TO RELATED APPLICATION(S)

This application claims priority to and the benefit of U.S. Provisional Patent Application No. 63/187,062, filed on May 11, 2021, which is hereby incorporated by reference herein in its entirety

### TECHNICAL FIELD

The present disclosure relates generally to production of fertilizers, and more particularly, to systems and methods of preparing a fertilizer using cactus.

### BACKGROUND

Synthetic fertilizers are widely used in modern agriculture because of the high levels of essential macro nutrients in the form of nitrogen (N), phosphorus (P), and potassium (K). However, synthetic fertilizers have wide-reaching environmental consequences. These include ocean dead zones and waterway contamination, soil degradation and loss, toxin accumulation in ecosystems, habitat destruction, and pressure on biodiversity. Accordingly, it is desirable to have a plant-based fertilizer with marketable levels of nitrogen (N), phosphorus (P), and potassium (K) that would not have such adverse environmental consequences.

### SUMMARY

According to some implementations of the present disclosure, a method of preparing a fertilizer product includes grinding cladodes of one or more cactus plants into ground cactus and selecting prickly pear fruits from the one or more cactus plants. The method further includes combining the ground cactus, the selected prickly pear fruits, water, and a ruminal fluid in a first container to form a mixture. The method further includes storing the mixture in the first container for a first time period such that the mixture reacts to form a digestate. The method further includes storing the digestate in the first container or a second container for a second time period such that the digestate forms the fertilizer product.

According to some implementations of the present disclosure, a system for preparing a plant-based fertilizer includes a grinder, at least one biodigester, and an electrical control unit. The grinder is configured to grind cladodes of one or more cactus plants into ground cactus. The at least one biodigester is configured to inhibit entry of air and light and store, for enabling a fermentation process, a mixture of the ground cactus, selected prickly pear fruits, water, and a ruminal fluid for a first time period such that the mixture reacts to form a digestate. The electrical control unit is configured to regulate the temperature and pressure of the at least one biodigester.

The above summary is not intended to represent each implementation or every aspect of the present disclosure. Additional features and benefits of the present disclosure are apparent from the detailed description and figures set forth below.

### BRIEF DESCRIPTION OF THE DRAWINGS

FIG. 1 illustrates a functional block diagram of a fertilizer ecosystem, according to some implementations of the present disclosure.

FIG. 2 illustrates a perspective view of a farm of cactus plants, according to some implementations of the present disclosure.

FIG. 3 illustrates a schematic diagram of a fertilizer plant of the ecosystem of FIG. 1 configured to prepare a fertilizer using cactus, according to some implementations of the present disclosure.

FIG. 4 illustrates a schematic diagram of a biodigester in the fertilizer plant of FIG. 3 using in preparing the fertilizer, according to some implementations of the present disclosure.

FIG. 5 illustrates a flow diagram for a method of preparing a fertilizer from cactus, according to some implementations of the present disclosure.

While the present disclosure is susceptible to various modifications and alternative forms, specific implementations thereof have been shown by way of example in the drawings and will herein be described in detail. It should be understood, however, that it is not intended to limit the present disclosure to the particular forms disclosed, but on the contrary, the present disclosure is to cover all modifications, equivalents, and alternatives falling within the spirit and scope of the present disclosure as defined by the appended claims.

### DETAILED DESCRIPTION

The systems and methods described herein can be configured to prepare a plant-based fertilizer from cactus. The systems and methods use a variety of cactus that is commonly found, for example, in regions of United States and Mexico with mild winters having a prolonged dry spell followed by hot summers with occasional rain and relatively low humidity. The cactus is used as a base ingredient for making a plant-based fertilizer with marketable levels of nitrogen (N), phosphorus (P), and potassium (K) and beneficial micronutrients. Additionally, any living organisms within the plant-based fertilizer, such as, but not limited to, bacteria and fungi like Bacillus and Trichoderma species known for promoting plant growth, are naturally produced. The plant-based fertilizer thus formed does not contain soil, earthworm casings, sludge, manure, farm waste, or other materials and can defend itself from unwanted organisms. Nitrogen water formed as a byproduct of the process can be used in hydroponic irrigation and other agricultural applications.

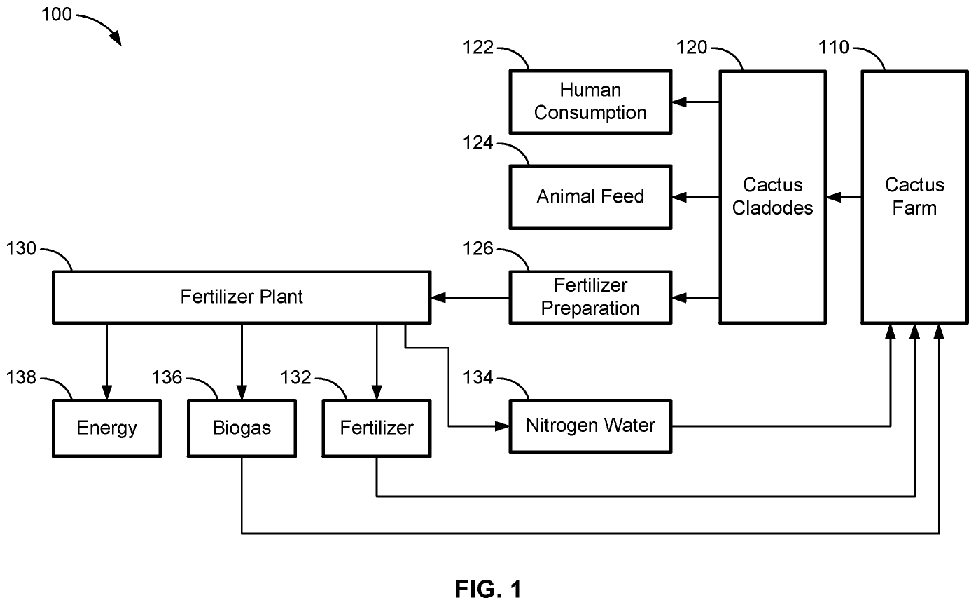

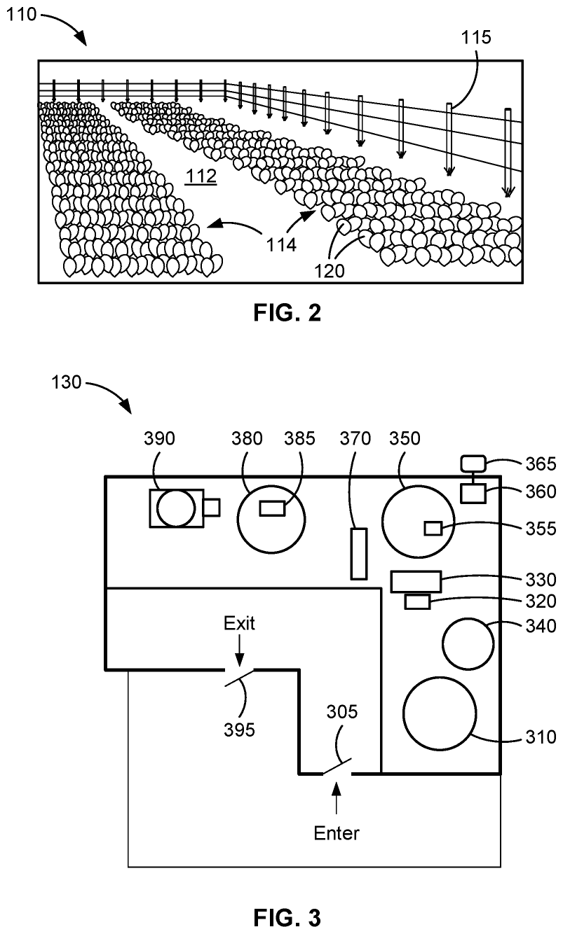

FIG. 1 illustrates a functional block diagram of a fertilizer ecosystem 100. The fertilizer ecosystem demonstrates the components of the fertilizer ecosystem 100 and how the components are interconnected in the cycle of the fertilizer ecosystem 100. The fertilizer ecosystem 100 includes a cactus farm 110, which is further illustrated in FIG. 2. The cactus farm produces cactus cladodes 120. The cactus cladodes 120 are flattened leaf-like stems of cactus plants in the cactus farm 110. The cactus cladodes 120 may be used for human consumption 122 as food and/or medicine or as animal feed 124, e.g., fodder for animals. The cactus cladodes 120 may also be used in fertilizer preparation 126, according to one or more implementations described below.

During fertilizer preparation 126, the cactus cladodes 120 are transferred to a fertilizer plant 130, which is further illustrated in FIG. 3. The fertilizer plant 130 uses the cactus cladodes 120 to produce a fertilizer 132, nitrogen water 134, and a biogas 136. The fertilizer plant 130 releases energy 138 in the form of a biogas (e.g., methane) which is captured and can be used for household and/or commercial purposes. The fertilizer 132, the nitrogen water 134, and the biogas 136 are re-used in the cactus farm 110 to aid in growing the cactus plants.

FIG. 2 illustrates a perspective view of a cactus farm 110 of cactus plants 114 grown in soil 112. In some implementations, the cactus farm 110 may have an area of at least about 1000 square meters and be surrounded by a fence 115. The cactus plants 114 may belong to the genus Opuntia. In some implementations, the cactus plants 114 belong to the species Opuntia ficus-indica, which is commonly known as Indian fig opuntia, fig opuntia or prickly pear. It is known for converting water into biomass efficiently and is grown as a fruit crop known for prickly pear fruits. The cactus plants 114 grow the cactus cladodes 120 as well as the prickly pear fruits.

FIG. 3 illustrates a schematic diagram of an example fertilizer plant 130 used for preparing a fertilizer using cactus. The fertilizer plant 130 has different processing stations located between an entry gate 305 and an exit gate 395. The raw materials for making the fertilizer from cactus are moved serially from one processing station to another in the fertilizer plant 130. After entering through the entry gate 305, the raw materials are washed at a washing station 310. The washing station 310 includes a large water tub for soaking the cactus cladodes 120. The washing station 310 includes cleaning supplies and tools such as, but not limited to, a water pressure gun, stainless steel brushes for machinery and large brooms for cleaning different processing stations.

The raw materials are then moved to a grinder 320, where a high volume of cactus cladodes 120 are ground to form ground cactus. In some implementations, the grinder 320 operates at a power of about 1000 horsepower or more to grind at least two cactus cladodes 120 per second, where each cactus cladode has a weight between about one kilograms and about two kilograms. In some implementations, the grinder 320 is dismantled after every batch of grinding.

The ground cactus is then mixed with a selection of prickly pear fruits (also known as ‘tuna’) and water. In some implementations, about eighty kilograms of cactus cladodes 120 is mixed with about twenty kilograms of prickly pear fruits.

A catchment 330 is positioned next to the grinder 320 to separate any liquid from a solid portion of the mixture of ground cactus and prickly pear fruits, thereby forming a homogeneous cactus mixture before processing.

A recipe-making station 340 is positioned adjacent to the grinder 320 and the catchment 330. The recipe-making station 340 is used for preparing a solution of an activating fluid by mixing a small amount of the homogeneous cactus mixture with a ruminal fluid extracted from cattle, as described below. The activating fluid, once prepared, generates enzymes, bacteria, and other microorganisms that aid in preparing the fertilizer.

A biodigester 350 is located adjacent to the grinder 320, the catchment 330, and the recipe-making station 340. The biodigester 350 can have a shape of a drum. The biodigester 350 is configured to inhibit entry of air and light to facilitate preparation of the fertilizer. In other words, the biodigester 350 may be a sealed container that is either fully opaque to visible light (between about 380-750 nanometers), or prevents entry of most of all the visible light. The contents of the biodigester 350 are shielded from air and light. The biodigester 350 includes one or more pipes (not shown) for delivering the homogeneous cactus mixture, the activating fluid, water, and any other ingredients into the biodigester 350 for the fertilizer. In some implementations, one or more sensors 355 such as, but not limited to, a temperature sensor, a pressure sensor, and a moisture sensor may be disposed in the biodigester 350 for taking temperature and pressure measurements respectively. In some implementations, the fertilizer plant 130 includes two or more of the biodigesters 350 to aid in producing a relatively higher volume of fertilizer.

The homogeneous cactus mixture as well as the ruminal fluid are poured separately into the biodigester 350, where they undergo an anaerobic fermentation process to produce a digestate, nitrogen water, and a biogas. In some implementations, about one hundred kilograms of the homogeneous cactus mixture (having about eighty kilograms of cactus cladodes 120 and about twenty kilograms of prickly pear fruits) is mixed with about one liter of the ruminal fluid with the goal of producing about 500 liters of the fertilizer. The one or more pipes in the biodigester 350 are cleaned after every batch of anaerobic fermentation process.

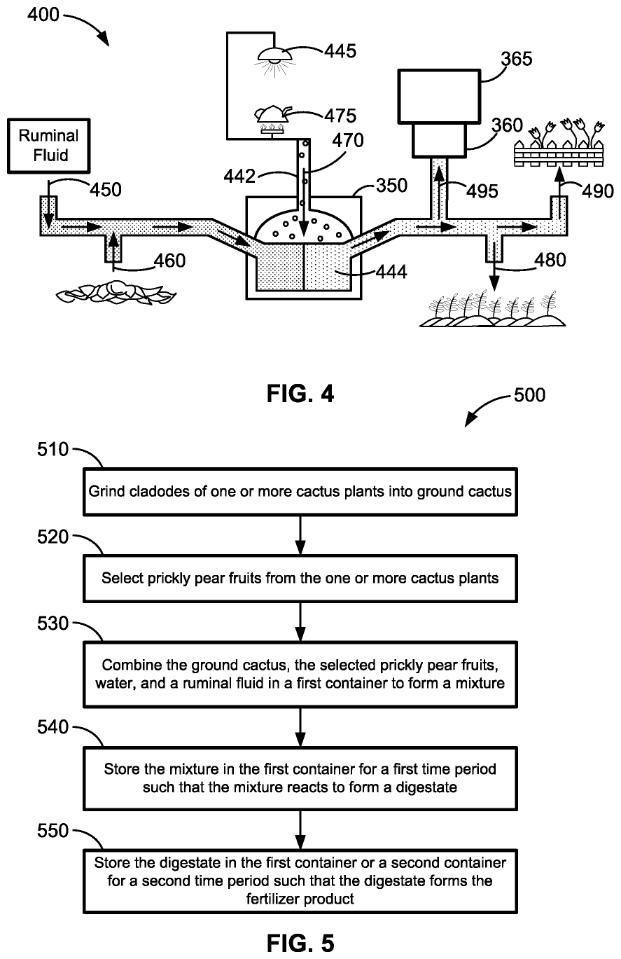

In FIG. 4, a schematic diagram of the biodigester 350 in the fertilizer plant 130 is shown. A gas extractor 360 is located at a rear end of the biodigester 350 and includes a conduit (not shown) for extracting the biogas released from the biodigester 350 during the anaerobic fermentation process. The gas extractor 360 is fluidly connected via the conduit to a gas storage tank 365. The gas storage tank 365 stores the biogas for subsequent distribution for household and commercial uses.

A filtering station 370 is positioned adjacent to the biodigester 350. The filtering station 370 is configured to separate any particulate matter in the digestate. The resultant digestate is then moved to a packing station 380.

The packing station 380 includes a storage container 385 for storing the digestate for at least about 7 days, until the fertilizer is formed. The storage container is configured to inhibit entry of air and light. for at least about 7 days, until the fertilizer is formed. The fertilizer, once formed, is packed into product containers at the packing station 380 for subsequent distribution.

The fertilizer plant 130 is powered by an electrical control unit 190 located at one end of the fertilizer plant 130. The electrical control unit 190 is communicatively coupled to the one or more sensors 355 in the fertilizer plant 130 such as, but not limited to, a temperature sensor, a pressure sensor, and a moisture sensor disposed in the biodigester 350 and the packing station 380. The electrical control unit 190 is configured to regulate the temperature and pressure of the biodigester 350 by communicating with the one or more sensors 355 disposed in the biodigester 350. The measurements taken by the temperature sensor, the pressure sensor, and the moisture sensor enable the electrical control unit 190 to regulate the temperature, pressure, and moisture content within the biodigester 350 and the packing station 380.

In some implementations, the electrical control unit 190 may include a memory device (not shown) and one or more processors (not shown) configured to execute machine-readable instructions stored in the memory device in order to control power supply and regulate various aspects of the fertilizer plant 130 such as, but not limited to, the temperature, pressure, and moisture content within the biodigester 350. In some implementations, the electrical control unit 190 may also include an electronic interface (not shown) configured to communicate, using a wired or wireless network, with the one or more sensors located throughout the fertilizer plant 130. In some implementations, the electrical control unit 190 may include a user interface (not shown) for communicating with a user, as well as a speaker (not show) for providing alerts and updates regarding the various components and processes in the fertilizer plant 130. In some embodiments, the electrical control unit 190 may be communicatively connected with one or more cameras located throughout the fertilizer plant in order to receive image data regarding different processes and occurrences in the fertilizer plant 130.

Referring to FIG. 4, a schematic diagram of the biodigester 350 is shown. The biodigester 350 includes a large drum 444 and a tube 442 for adding water therein. A ruminal fluid 450 extracted from cattle and a homogeneous cactus mixture 460 (comprising the majority of the solid portion of the mixture of ground cactus and prickly pear fruits, as described above) are added into the biodigester 350 for anaerobic fermentation. The biodigester 350 has a heating source 445 for applying heat to the anaerobic fermentation process and a kettle 475 for inputting hot water 470 into the biodigester through the tube 442. The homogeneous cactus mixture 460 as well as the ruminal fluid 450 undergo an anaerobic fermentation process in the large drum 444 of the biodigester 350 at a temperature between about 25° C. and about 40° C. and a pressure between about 75 psi and about 85 psi for about 15 to 22 days. In some implementations, the temperature of the biodigester 350 is about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., or about 40° C. In some implementations, the pressure of the biodigester 350 is about 75 psi, about 76 psi, about 77 psi, about 78 psi, about 79 psi, about 80 psi, about 81 psi, about 82 psi, about 83 psi, about 84 psi, or about 85 psi. In some implementations, the anaerobic fermentation in the biodigester 350 can occur for about 15 days, about 16 days, about 17 days, about 18 days, about 19 days, about 20 days, about 21 days, or about 22 days. It is contemplated that the methods of the present disclosure for the anaerobic fermentation process can occur at any combination of the temperatures and pressures for any number of days described above (e.g., at about 35° C. and 80 psi for about 18 days, etc.).

A digestate is formed as a result of the anaerobic fertilization process and subsequently transferred to the storage container 385 in the packing station 380, where the digestate is stored at room temperature (not more than 38° C.) and pressure, for at least 7 days to form the fertilizer 480. Nitrogen water 490, having 98% water, is formed as a byproduct of the anaerobic fertilization process and can be captured and used, for example, in hydroponic irrigation and other irrigation applications. A biogas 495 can also be extracted from the biodigester 350 using the gas extractor 360 and stored in the gas storage tank 365. The biogas can be used, for example, to fill propane tanks and also sold for domestic use such as lighting an outdoor grill or a gas stove.

FIG. 5 illustrates a flow diagram 500 for a method of preparing a fertilizer from cladodes of a cactus plant. The cladodes are between about 30 cm and about 50 cm in length and selected from cactus plants belonging to the species Opuntia ficus-indica of the genus Opuntia. The selected cladodes are ripe and fresh, and formed within less than about six months of germination of the cactus plant. The cladodes have a dark-greenish tone without any spots or stings and are without any pests or diseases. The selected cladodes are submerged in water to clean any soil waste and eliminate unwanted wildlife from there. The cleaning may be performed at the washing station 310 of the fertilizer plant 130.

The method begins at step 510 by grinding cladodes of one or more cactus plants to form ground cactus. This step may be performed at the grinder 320 of the fertilizer plant 130. At step 520, prickly pear fruits are selected from the one or more cactus plants. A homogeneous cactus mixture is formed by separating any liquid portion from a solid portion of a mixture of ground cactus, prickly pear fruits, and water. The separation may be performed at the catchment 330 of the fertilizer plant 130. A small amount of the homogeneous cactus mixture is then mixed with a ruminal fluid to prepare a solution of an activating fluid. The activating fluid generates enzymes, bacteria, and other microorganisms that aid in preparing the fertilizer.

The ruminal fluid is extracted from cattle for mixing with the homogeneous cactus mixture. The ruminal fluid acts as an inoculum for the homogeneous cactus mixture because it boosts cactus decomposition and activates bacteria and other micronutrients within the homogeneous cactus mixture. In some implementations, the cattle may be one or more calves that are between about six months and about twelve months old. The calves are provided a strict diet of about 20% fodder and about 80% cladodes of the cactus plant. The fodder may include oats and ground alfalfa. The diet is provided at about 8:00 am and about 6:00 pm daily for about 30 days.

A nasogastric tube, about 1.8 meters in length and 5 millimeters in diameter, is disinfected and placed through the nostril, pharynge, and esophagus into the rumen level in the stomach of the calves. The ruminal fluid from the stomach of the calves is extracted using an automatic oral gun positioned at the exterior end of the nasogastric tube. About 60 milliliters of ruminal fluid can be extracted each time using the automatic oral gun. About 100 milliliters of extracted ruminal fluid is placed in a closed container having a volume of 500 milliliters and stored at a temperature between about 25° C. and about 35° C., without exposure to sunlight.

At step 530, the ground cactus, the selected prickly pear fruits, water, and the ruminal fluid are combined in a first container to form a mixture. In some embodiments, the homogeneous cactus mixture (formed by mixing the ground cactus, the selected prickly pear fruits, and water in step 520) is combined with the activating fluid to form the mixture. The first container may be the biodigester 350 of the fertilizer plant 130, as shown in FIG. 4. The ruminal fluid is collected from the closed container using a syringe having a volume of 50 milliliters. The collected ruminal fluid is mixed with the homogeneous cactus mixture in a sealed container.

At step 540, the mixture is stored in the first container for a first time period such that the mixture reacts to form a digestate. In some implementations, the mixture undergoes a metabolic reaction including an anaerobic fermentation process in the biodigester 350 in the absence of air and light. This step may also be performed in the biodigester 350 of the fertilizer plant 130. The anaerobic fermentation may be performed at a predetermined temperature between about 25° C. and about 40° C. Maintaining the temperature within a controlled range allows the bacteria, the microorganisms, and the essential nutrients of the cactus plant to be preserved under ideal conditions. The anaerobic fermentation may be performed at a predetermined pressure between about 75 psi and about 85 psi. The anaerobic fermentation process occurs and is generally completed between about 15 days and about 22 days. In short, the mixture is stored at the above-described temperature and pressure for the above number of days such that the digestate is formed through the anaerobic fermentation process. The temperature, pressure, and the number of days for completion of the anaerobic fermentation process is directly proportional to the amounts of cactus cladodes 120, prickly pear fruits, and ruminal fluid mixed in the biodigester 350. The digestate thus formed has a higher viscosity than the mixture of ingredients before the anaerobic fermentation process is initiated.

During anaerobic fermentation, organic compounds such as complex sugars, organic acids, and alcohols in the homogeneous cactus mixture are broken down by natural-occurring bacteria and archaea, in the absence of oxygen. As a result of anaerobic fermentation, the digestate containing plant nutrients, a biogas (a mixture of methane, carbon dioxide, water vapor, ammonia, and hydrogen sulfide gases, etc.) and energy are formed. The nitrogen (N), phosphorus (P), and potassium (K) content of the organic compounds in the homogeneous cactus mixture are transformed, without any loss or reduction, from organic forms to inorganic forms (e.g. ammonium, nitrites, nitrates, and inorganic phosphorus) in the digestate, while the carbon is converted to biogas. Nitrogen gas and water are then formed, for example, by (i) denitrification of the nitrates in the absence of oxygen, or (ii) further oxidation of ammonium by the nitrites in the absence of oxygen. The nitrogen gas dissolves in the water, thus forming nitrogen water as a byproduct of the anaerobic fermentation process.

At step 550, the digestate is stored in the first container or a second container for a second time period such that the digestate forms the fertilizer product. This step may be performed at room temperature and pressure in the biodigester 350 or preferably, in the packing station 380 of the fertilizer plant 130. The second time period may be between about 6 days and about 10 days and allows the microorganisms in the digestate to fully develop. The digestate thus contains all the macro elements of the cactus plant in liquid form and is capable of acting like a fertilizer to nourish and regenerate soils and plants, after the storage for the second time period. The fertilizer thus formed can be packaged using product containers, which ensure there is no direct contact with light, which causes the fertilizer to break down and lose valuable nutrients.

The plant-based fertilizer thus formed has greater than 6.5% nitrogen, 1% phosphorus, and 15% potassium, which is thus significantly more nutrient-rich compared to other plant-based fertilizers such as molasses, corn gluten meal, soybean meal, kelp/seaweed, cottonseed meal, alfalfa meal, compost, and the like. The levels of nitrogen, phosphorus, and potassium can be controlled by varying temperatures and pressure of the anaerobic fermentation process. In some implementations, the plant-based fertilizer has been determined to have about contains about 8% nitrogen, about 2% phosphorus, and about 27% potassium. Since the plant-based fertilizer thus formed is made from a single main source, (e.g., cactus plants), it is also more cost-effective in manufacturing, which allows it to be priced competitively compared to other fertilizers have similar levels of nitrogen, phosphorus, and potassium.

One or more elements or aspects or steps, or any portion(s) thereof, from one or more of any of claims 1 to 20 below can be combined with one or more elements or aspects or steps, or any portion(s) thereof, from one or more of any of the other claims 1 to 20 or combinations thereof, to form one or more additional implementations and/or claims of the present disclosure.

While the present disclosure has been described with reference to one or more particular implementations, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations according to aspects of the present disclosure may combine any number of features from any of the implementations described herein.

1. A method of preparing a fertilizer product, the method comprising:
grinding cladodes of one or more cactus plants into ground cactus;
selecting prickly pear fruits from the one or more cactus plants;
mixing a portion of the ground cactus and the selected prickly pear fruits with a ruminal fluid to prepare an activating fluid;
combining the ground cactus, the selected prickly pear fruits, water, and the activating fluid in a first container to form a mixture;
storing the mixture in the first container for a first time period such that the mixture reacts to form a digestate; and
storing the digestate in the first container or a second container for a second time period such that the digestate forms the fertilizer product.

2. The method of claim 1, wherein the first container and the second container are configured to inhibit entry of air and light.

3. The method of claim 1, wherein the digestate is stored at room temperature and pressure.

4. (canceled)

5. The method of claim 1, wherein the one or more cactus plants belong to the species Opuntia ficus-indica.

6. The method of claim 1, further comprising, prior to the grinding, selecting a plurality of cladodes of the one or more cactus plants, each of the selected plurality of cladodes being between about 30 cm and about 50 cm in length.

7. The method of claim 1, further comprising, prior to the grinding, cleaning the cladodes with water.

8. The method of claim 1, wherein the storing the mixture in the first container includes permitting the digestate to ferment in the first container.

9. The method of claim 1, further comprising maintaining an internal temperature of the first container between about 25 degrees Celsius and about 40 degrees Celsius and maintaining an internal pressure of the first container between about 75 psi and about 85 psi.

10. (canceled)

11. The method of claim 1, wherein the first time period is between about 15 days and about 22 days and the second time period is between about 6 days and about 10 days.

12. (canceled)

13. The method of claim 1, wherein the ruminal fluid is extracted from one or more calves using a nasogastric tube.

14. The method of claim 13, wherein prior to the ruminal fluid being extracted, the one or more calves are provided a diet of about 20% fodder and about 80% cladodes of cactus plants.

15. The method of claim 13, further comprising, prior to the combining the ground cactus, the selected prickly pear fruits, water, and the ruminal fluid, storing the extracted ruminal fluid in a third container at a temperature between about 25 degrees Celsius and about 35 degrees Celsius, the third container configured to inhibit entry of air and light.

16. (canceled)

17. A system for preparing a plant-based fertilizer, the system comprising:
a grinder configured to grind cladodes of one or more cactus plants into ground cactus;
a container configured to store an activating fluid, wherein the activating fluid is a mixture of a portion of the ground cactus and a ruminal fluid;
at least one biodigester configured to inhibit entry of air and light and store, for enabling a fermentation process, a mixture of the ground cactus, selected prickly pear fruits, water and the activating fluid for a first time period such that the mixture reacts to form a digestate; and
an electrical control unit configured to regulate the temperature and pressure of the at least one biodigester.

18. The system of claim 17, further comprising:
a storage container configured to store the digestate for a second time period such that the digestate forms the fertilizer product, the storage container configured to inhibit entry of air and light.

19. The system of claim 17, further comprising:
a filtering station configured to separate particulate matter in the digestate before storing the digestate in the storage container.

20. The system of claim 17, further comprising:
a gas extractor configured to extract a biogas released during the fermentation process.

21. The method of claim 1, further comprising:
the first container having a first temperature and a first pressure and the second container having a second temperature and a second pressure, wherein the first temperature is higher than the second temperature and the first pressure is higher than the second pressure.

22. The system of claim 17, wherein the at least one biodigester includes a first biodigester and a second biodigester, wherein the first biodigester has a first temperature and a first pressure and the second biodigester has a second temperature and a second pressure, wherein the first temperature is higher than the second temperature and the first pressure is higher than the second pressure, wherein the first biodigester stores the mixture for a first time period and the second biodigester stores the mixture for a second time period.

23. The system of claim 22, wherein the mixture is stored in the first biodigester to form a digestate, and wherein the mixture is stored in the second biodigester to form the plant-based fertilizer.

24. The method of claim 1, further comprising:
a step of separating particulate matter in the digestate before storing the digestate in the second container.

25. (canceled)
